(19) United States
(12) Patent Application Publication
(10) Pub. No.: US 2026/0281710 A1
(43) Pub. Date: Sep. 17, 2026

(54) COMMUNICATION CONTROL METHOD, COMMUNICATION NODE, AND WIRELESS COMMUNICATION SYSTEM

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/677,667

(22) Filed: May 14, 2026

Related U.S. Application Data
(63) Continuation of application No. PCT/JP2024/040120, filed on Nov. 12, 2024.

(30) Foreign Application Priority Data
Nov. 14, 2023 (JP) 2023-193826

(51) Int. Cl. H04W 8/24

(52) U.S. Cl. CPC H04W 8/24

(57) ABSTRACT

In an aspect, a communication control method is a communication control method in a wireless communication system. The communication control method includes transmitting, at a communication node, at least one selected from the group consisting of a first unmodulated signal, a preamble signal, a signal representing identifier information of an IoT device, and a signal representing control information relating to backscattering transmission as a transmission signal to the IoT device. The communication control method includes receiving, at the IoT device, the transmission signal. The communication control method includes transmitting, at the communication node, a second unmodulated signal. The communication control method further includes performing, at the IoT device, the backscattering transmission on the second unmodulated signal using the transmission signal.

### RELATED APPLICATIONS

The present application is a continuation based on PCT Application No. PCT/JP2024/040120, filed on Nov. 12, 2024, which claims the benefit of Japanese Patent Application No. 2023-193826 filed on Nov. 14, 2023. The content of which is incorporated by reference herein in their entirety.

### TECHNICAL FIELD

The present disclosure relates to a communication control method and a user equipment.

### BACKGROUND

In recent years, the Internet of Things (IoT) has gained attention in the wireless communication technology. It is expected that more “things” are connected with each other to improve production efficiency and enhance comfort of life compared to the conventional art.

Examples of a technology used for the IoT include barcodes and Radio Frequency IDentifiers (RFIDs). However, there is no interference management scheme for barcodes and RFIDs. Hence, it may be difficult to support large-scale networks with barcodes and RFIDs.

In recent years, in the Third Generation Partnership Project (3GPP) (registered trade mark. The same applies hereinafter) that is a standardization project for mobile communication systems, the feasibility of a new IoT technology is being studied. The IoT technology is assumed as a technology with a larger number of connections and a higher device density than those of the existing IoT technologies in 3GPP. The IoT technology is assumed as a technology with less complexity and power consumption than those of the existing 3GPP Low Power Wide Area (LPWA) technologies such as Narrow Band-IoT (NB-IoT) or Long Term Evolution-Machine Type Communication (LTE-MTC). An IoT device used by the IoT technology is called an ambient IoT device.

### CITATION LIST

### Non-Patent Literature

### Non-patent Document 1: 3GPP TR 38.848 V18.0.0 (2023 September)

### SUMMARY

In a first aspect, a communication control method is a communication control method in a wireless communication system. The communication control method includes transmitting, at a communication node, at least one selected from the group consisting of a first unmodulated signal, a preamble signal, a signal representing identifier information of an IoT device, and a signal representing control information relating to backscattering transmission as a transmission signal to the IoT device. The communication control method includes receiving, at the IoT device, the transmission signal. The communication control method includes transmitting, at the communication node, a second unmodulated signal. The communication control method further includes performing, at the IoT device, the backscattering transmission on the second unmodulated signal using the transmission signal.

In a second aspect, a communication node is a user equipment in a wireless communication system. The user equipment includes a transmitter configured to transmit a transmission signal including at least one selected from the group consisting of a first unmodulated signal, a preamble signal, a signal representing identifier information of an IoT device, and a signal representing control information relating to backscattering transmission to the IoT device. The transmitter is configured to transmit the second unmodulated signal. The IoT device is configured to perform the backscattering transmission on the second unmodulated signal using the transmission signal.

### BRIEF DESCRIPTION OF THE DRAWINGS

FIG. 1 is a diagram illustrating a configuration example of a wireless communication system according to a first embodiment.

FIG. 2 is a diagram illustrating a configuration example of a User Equipment (UE) according to the first embodiment.

FIG. 3 is a diagram illustrating a configuration example of a gNB according to the first embodiment.

FIG. 4 is a diagram illustrating a configuration example of an ambient IoT device according to the first embodiment.

FIG. 5 is a diagram illustrating a configuration example of a protocol stack relating to a user plane according to the first embodiment.

FIG. 6 is a diagram illustrating a configuration example of a protocol stack relating to a control plane according to the first embodiment.

FIG. 7 is a diagram illustrating a communication example according to the first embodiment.

FIGS. 8A and 8B are diagrams illustrating configuration examples of a topology according to the first embodiment.

FIG. 9A and FIG. 9B are diagrams illustrating configuration examples of the topology according to the first embodiment.

FIG. 10 is a diagram illustrating a configuration example of the topology according to the first embodiment.

FIGS. 11A and 11B are diagrams illustrating an example of a multiple access method according to the first embodiment.

FIG. 12 is a diagram illustrating a configuration example of a protocol stack relating to ambient IoT according to the first embodiment.

FIGS. 13A to 13D are diagrams illustrating examples of signal formats of a DL command according to the first embodiment.

FIG. 14 is a diagram illustrating an operation example according to the first embodiment.

FIG. 15 is a diagram illustrating an operation example according to a second embodiment.

FIG. 16 is a diagram illustrating a communication example according to a third embodiment.

FIG. 17 is a diagram illustrating an operation example according to the third embodiment.

### DESCRIPTION OF EMBODIMENTS

An aspect enables appropriate control of communication in an IoT device.

Most of existing wireless communication devices use batteries that need to be manually exchanged and need to be manually charged. On the other hand, driving all IoT devices with the batteries requires not only the cost of the IoT devices but also maintenance cost of the IoT devices, and therefore is difficult to implement.

Firstly, the ambient IoT device described above is assumed to function as a batteryless device that does not have an energy storage function. In this case, the ambient IoT device functions as a pure batteryless device that does not have a power storage function at all and depends completely on availability of an external energy source.

Secondly, the ambient IoT device is assumed to function as a battery device having a limited energy storage function. The limited energy storage function is, for example, an energy storage function that does not need to be manually exchanged and does not need to be manually charged.

A specific example of the ambient IoT device will be described later. As described above, the technology that uses the ambient IoT devices is assumed to be a technology with a large number of connections and less complexity and power consumption compared to the existing 3GPP technology. It is expected that use of such an ambient IoT device will open up a new market as automation and digitalization advance in various industries.

Hereinafter, a wireless communication system according to an embodiment will be described with reference to the drawings. In the description of the drawings, the same or similar parts are denoted by the same or similar reference signs. The ambient IoT device is used in the wireless communication system according to the embodiment.

### First Embodiment

### Configuration Example of Wireless Communication System

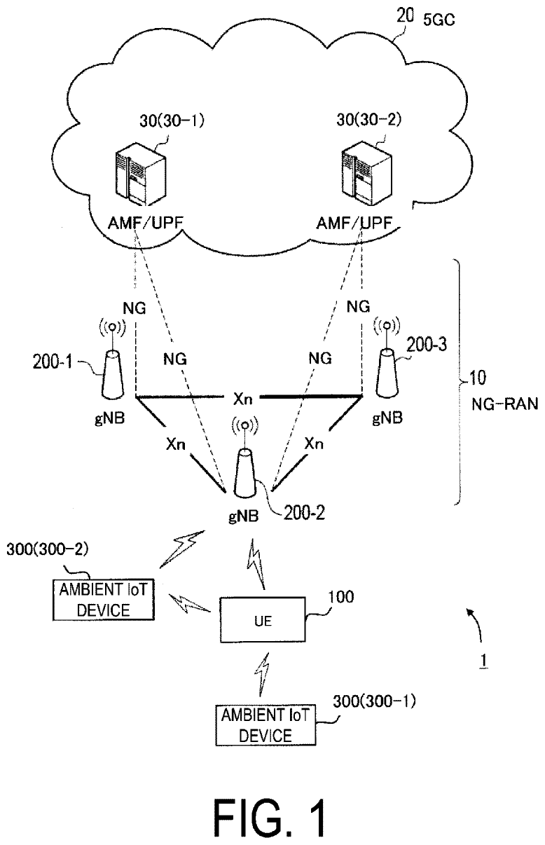

FIG. 1 is a diagram illustrating a configuration example of the wireless communication system according to a first embodiment. A wireless communication system 1 includes a mobile communication system that is the 5th Generation System (5GS) of the 3GPP standard. The description below takes the 5GS as an example of the mobile communication system, but a Long Term Evolution (LTE) system may at least partially be applied. As the mobile communication system, a sixth generation (6G) system or a subsequent system may at least partially be applied. Note that the wireless communication system 1 may be the mobile communication system.

The wireless communication system 1 includes a User Equipment (UE) 100, a 5G radio access network (NG-RAN: Next Generation Radio Access Network) 10, a 5G Core Network (5GC) 20, and ambient IoT devices 300. The 5GC 20 may be hereinafter simply referred to as the core network (CN) 20. Note that a node other than the UE 100 may be present between the gNBs 200 and the ambient IoT devices 300. Such a node may be referred to as an assisting node or an intermediate IAB node. The assisting node and the intermediate node will be described in detail later.

The UE 100 is a mobile wireless communication apparatus. The UE 100 may be any apparatus as long as it is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes the base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a Radio Resource Management (RRM) function, a function of routing user data (hereinafter simply referred to as “data”), a measurement control function for mobility control and scheduling, and the like. Note that a “cell” is used as a term indicating a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be also connected to an Evolved Packet Core (EPC) that is a core network of LTE. An LTE base station can also be connected to the 5GC. The LTE base station and the gNB can be connected via an inter-base station interface.

The 5GC 20 includes an Access and Mobility Management Function (AMF) 30 and a User Plane Function (UPF). The AMF 30 performs various types of mobility control and the like for the UE 100. The AMF 30 manages mobility of the UE 100 by communicating with the UE 100 by using Non-Access Stratum (NAS) signaling. The UPF controls data transfer. The AMF 30 and the UPF are connected to the gNB 200 via an NG interface, which is an interface between the base station and the core network.

The ambient IoT device 300 is a wireless communication apparatus capable of wireless communication with the UE 100 and/or the gNB 200. The ambient IoT device 300 may wirelessly communicate with an assisting node or an intermediate node as described below.

Firstly, by reflecting a radio wave transmitted from the UE 100 or the gNB 200 and modulating the reflected wave, the ambient IoT device 300 can transmit information on the inside the ambient IoT device 300. In general, a technology of reflecting an unmodulated radio wave, modulating the reflected wave, and transmitting information will be referred to as backscattering communication. The ambient IoT device 300 has a backscattering communication function. The ambient IoT device 300 may be an information medium capable of reading information from an internal memory by using the backscattering communication function. The ambient IoT device 300 may be an information medium capable of writing information in the internal memory. In this case, by receiving a transmitted radio wave in which information has been modulated, and demodulating the received radio wave, the ambient IoT device 300 can extract the information.

Secondly, the ambient IoT device 300 may be a batteryless IoT device. In this case, the ambient IoT device 300 converts a received radio wave into energy (specifically, electric power) and operates using the energy. The ambient IoT device 300 may use other than radio waves as an energy source, and may convert other than radio waves into energy using, for example, light, heat, magnetism, vibration, or sound. Such energy conversion is generally referred to as energy harvesting. Known methods may be used for the energy harvesting. As described above, the ambient IoT device may have an energy harvesting function. The ambient IoT device 300 may have a limited battery function. As described above, the “limited battery” is a battery that does not need to be manually exchanged and does not need to be manually charged. The ambient IoT device 300 may have a battery function of charging with electric power acquired by the energy harvesting function. The ambient IoT device 300 may be a wireless tag.

### Configuration Example of UE

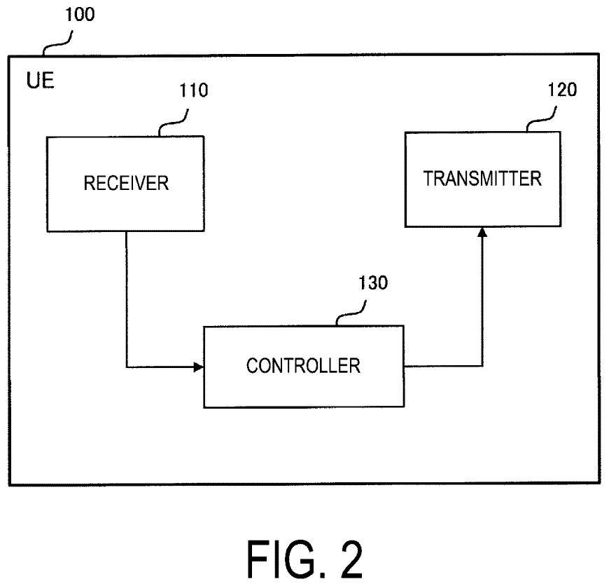

FIG. 2 is a diagram illustrating a configuration example of the user equipment 100 (UE) according to the first embodiment. The UE 100 includes a receiver 110, a transmitter 120, and a controller 130. The receiver 110 and the transmitter 120 constitute a wireless communicator that performs wireless communication with the gNB 200. The receiver 110 and the transmitter 120 can wirelessly communicate with the ambient IoT device 300.

The receiver 110 performs various receptions under the control of the controller 130. The receiver 110 includes an antenna and a reception device. The reception device converts a radio signal received through the antenna into a baseband signal (a reception signal) and outputs the resulting signal to the controller 130. The receiver 110 may receive a reflected wave reflected by the ambient IoT device 300 under the control of the controller 130. The receiver 110 receives the received reflected wave as a radio signal, converts the radio signal into a baseband signal, and outputs the baseband signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal, and transmits the resulting signal through the antenna. The transmitter 120 (or the transmission device) may transmit an unmodulated carrier wave under the control of the controller 130. The carrier wave is reflected by the ambient IoT device 300.

The controller 130 performs various controls and processes in the UE 100. Such processing includes processing of respective layers to be described later. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. In the example described below, operations or processing in the UE 100 may be performed by the controller 130.

### Configuration Example of gNB

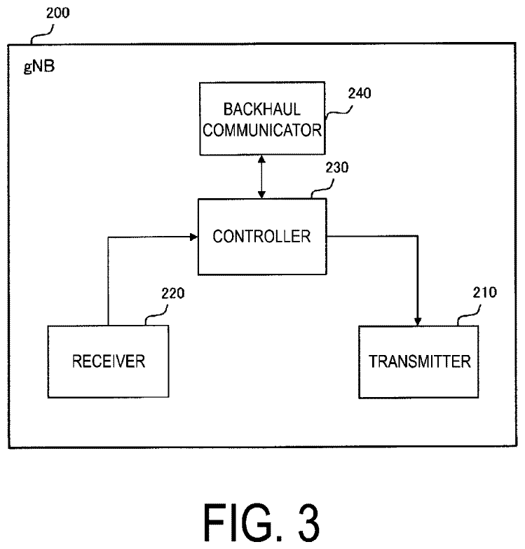

FIG. 3 is a diagram illustrating a configuration example of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The transmitter 210 and the receiver 220 can wirelessly communicate with the ambient IoT device 300. The backhaul communicator 240 constitutes a network communicator that performs communication with the CN 20.

The transmitter 210 performs various transmissions under the control of the controller 230. The transmitter 210 includes an antenna and a transmission device. The transmission device converts a baseband signal (a transmission signal) output by the controller 230 into a radio signal, and transmits the resulting signal through the antenna. The transmitter 210 (or the transmission device) may transmit an unmodulated carrier wave under the control of the controller 230. The carrier wave is reflected by the ambient IoT device 300.

The receiver 220 performs various types of reception under control of the controller 230. The receiver 220 includes an antenna and a reception device. The reception device converts a radio signal received through the antenna into a baseband signal (a reception signal), and outputs the resulting signal to the controller 230. The receiver 220 may receive a reflected wave reflected by the ambient IoT device 300 under the control of the controller 230. The receiver 220 receives the received reflected wave as a radio signal, converts the radio signal into a baseband signal, and outputs the baseband signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing in the gNB 200 may be performed by the controller 230.

The backhaul communicator 240 is connected to a neighboring base station via an Xn interface which is an inter-base station interface. The backhaul communicator 240 is connected to the AMF 30/UPF via the NG interface between the base station and the core network. Note that the gNB 200 may include a Central Unit (CU) and a Distributed Unit (DU) (i.e., functions are divided), and both units may be connected via an F1 interface that is a fronthaul interface.

### Configuration Example of Ambient IoT Device

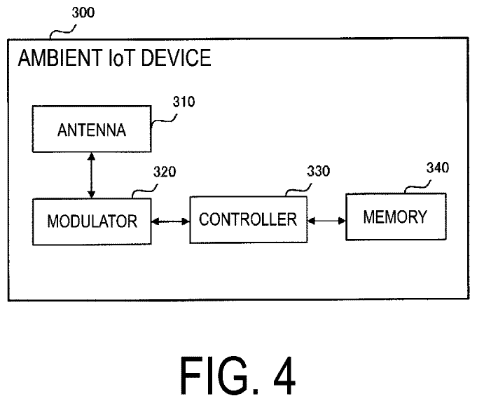

FIG. 4 is a diagram illustrating a configuration example of the ambient IoT device 300 according to the first embodiment. The ambient IoT device 300 according to the first embodiment includes an antenna 310, a modulator 320, a controller 330, and a memory 340.

The antenna 310 receives an unmodulated carrier wave. The unmodulated carrier wave will be referred to as a Continuous Wave (CW) below. The antenna 310 converts the received CW into a reception signal, and outputs the reception signal to the modulator 320. The antenna 310 reflects the CW and transmits the reflected wave according to the transmission signal output from the modulator 320. The reflected wave is hereinafter referred to as Back Scattering (BS). The antenna 310 performs BS transmission.

Under the control of the controller 330, the modulator 320 may modulate the data read from the memory 340 to generate a transmission signal. The modulator 320 outputs the modulated signal to the antenna 310. Under the control of the controller 330, the modulator 320 may demodulate the reception signal from the antenna 310 to acquire data. The modulator 320 outputs the acquired data to the controller 330. In the ambient IoT device 300, the modulator 320 may specifically be a switch. When receiving the reception signal from the antenna 310, the switch is turned on and outputs the reception signal to the controller 330. The switch is controlled to be turned on or off under the control of the controller 330, and outputs a transmission signal corresponding to on or off to the antenna 310. The switch may be a Radio Frequency (RF) switch. The switch may be configured with a transistor. The switch may be a mechanical switch capable of being physically turned on or off.

The controller 330 has an energy harvesting function of converting the reception signal received from the modulator 320 into electric power. The controller 330 controls the modulator 320 and the memory 340 using the electric power as driving electric power of the ambient IoT device 300. The controller 330 reads information stored in the memory 340, and controls the modulator 320 to cause the modulator 320 to transmit the transmission signal corresponding to the information. For example, the controller 330 can control the reflectance of a reflected wave (BS) (e.g., whether to set the reflectance to 100% or 0%) by controlling on or off of the modulator 320, and output a transmission signal corresponding to information (e.g., one bit) stored in the memory 340 from the modulator 320 to the antenna 310. By, for example, controlling a timing to turn on or off the modulator 320, the controller 330 can output a transmission signal corresponding to a plurality of bits from the modulator 320 to the antenna 310. As described above, by controlling on or off of the modulator 320, the controller 330 can control the reflectance of the reflected wave (BS), and transmit from the antenna 310 the modulated reflected wave corresponding to the information stored in the memory 340.

The memory 340 holds various types of pieces of information. The information held in the memory 340 may be information acquired when the ambient IoT device 300 functions as a sensor. The information held in the memory 340 may be information that is held in the memory 340 in advance and unique to the ambient IoT device 300. Examples of the unique information include identification information of the ambient IoT device 300 (a group to which the ambient IoT device 300 belongs). The memory 340 can read the held information under the control of the controller 330. Information may be written in the memory 340 under the control of the controller 330. In this case, the controller 330 (or the modulator 320) converts the reception signal received from the antenna 310 into a baseband signal of a baseband, reads information from the baseband signal, and writes the read information in the memory 340.

Note that the ambient IoT device 300 may also have a limited battery. As described above, the word “limited” is a battery that does not need to be manually exchanged and does not need to be manually charged. The ambient IoT device 300 may have the above-described energy harvesting function.

### Protocol Stack

A configuration example of the protocol stack will be described. Here, a configuration example of the protocol stack in the UE 100, the gNB 200, and the AMF 30 will be described.

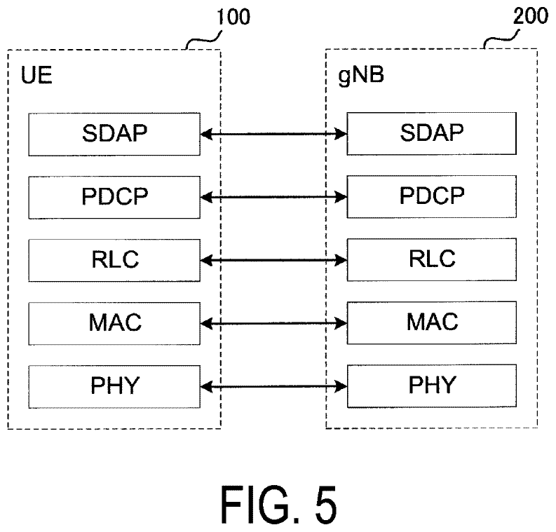

FIG. 5 is a diagram illustrating a configuration example of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives Downlink Control Information (DCI) transmitted from the gNB 200 over a Physical Downlink Control CHannel (PDCCH). Specifically, the UE 100 performs blind decoding of the PDCCH by using a Radio Network Temporary Identifier (RNTI) and acquires a successfully decoded DCI as a DCI addressed to the UE 100. The DCI transmitted from the gNB 200 is appended with Cyclic Redundancy Code (CRC) parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

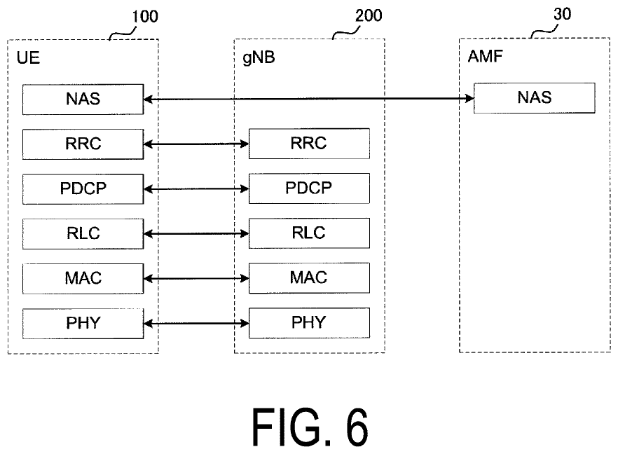

FIG. 6 is a diagram illustrating a configuration example of a protocol stack of a radio interface of a control plane handling signaling (a control signal).

The protocol stack of the radio interface of the control plane includes a Radio Resource Control (RRC) layer and a Non-Access Stratum (NAS) instead of the SDAP layer illustrated in FIG. 6.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 30. The UE 100 includes an application layer other than the protocol of the radio interface. A layer lower than the NAS will be referred to as an Access Stratum (AS).

### Communication Example of Ambient IoT Device

A communication example of the ambient IoT device 300 according to the first embodiment will be described.

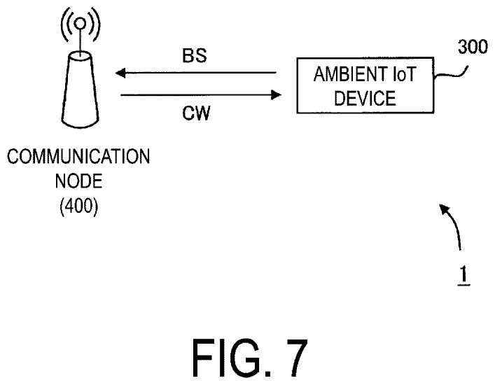

FIG. 7 is a diagram illustrating a communication example of the ambient IoT device 300 according to the first embodiment.

As illustrated in FIG. 7, a node (or a device) capable of directly communicating with the ambient IoT device 300 will be referred to as a communication node 400. The communication node 400 may be the UE 100 or the gNB 200. The communication node 400 may be a relay device. The communication node 400 may be referred to as an assisting node. The communication node 400 may be referred to as an intermediate node. The assisting node and the intermediate node will be described later. The communication node 400 may be an Integrated Access and Backhaul (IAB) node. The IAB node is, for example, a relay node that is interposed between the UE 100 and the gNB 200, and is a node to which a backhaul link (a communication link between the IAB node and the gNB 200) is connected mainly by wire. The communication node 400 may be a Network-Controlled Repeater (NCR). The NCR is, for example, a relay node that is interposed between the UE 100 and the gNB 200, and is a node with the gNB 200 and the NCR connected mainly by a wireless connection. The communication node 400 may be an eNB that is an LTE base station. The communication node 400 may be a network node that functions as a base station of 6G or subsequent generations.

The communication node 400 transmits an unmodulated Carrier Wave (CW). That is, the communication node 400 performs CW transmission. The ambient IoT device 300 reflects the unmodulated carrier wave and transmits the reflected wave. The reflected wave is modulated according to data transmitted from the ambient IoT device 300. That is, the ambient IoT device 300 performs BS transmission. The communication node 400 performs BS reception.

Note that, as for the communication node 400, a communication node that performs CW transmission and a communication node that performs BS reception may be different.

As described above, various modes are assumed as connection modes between the ambient IoT device 300 and the communication node 400 according to the type of the communication node 400. Various modes are assumed as a connection mode of the ambient IoT device 300 in the wireless communication system 1. 3GPP discusses four topologies assuming these connection modes as topologies. Hereinafter, the four topologies (topology 1, topology 2, topology 3, and topology 4) will be described.

### Topology of Ambient IoT Device 300

### (A1) Topology 1

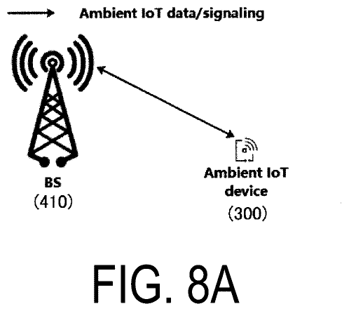

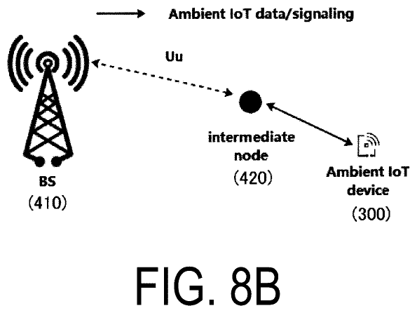

FIG. 8A is a diagram illustrating a configuration example of topology 1 according to the first embodiment.

As illustrated in FIG. 8A, in a case of topology 1, the ambient IoT device 300 directly and bidirectionally communicates with a Base Station (BS) 410. Data relating to the ambient IoT device 300 and/or signaling relating to the ambient IoT device 300 are transferred between the ambient IoT device 300 and the base station 410. In the case of topology 1, the base station 410 that performs CW transmission to the ambient IoT device 300 and the base station 410 that performs BS reception from the ambient IoT device 300 may be different. As for topology 1, an example where the communication node 400 is the base station 410 is described.

### (A2) Topology 2

FIG. 8B is a diagram illustrating a configuration example of topology 2 according to the first Embodiment.

As illustrated in FIG. 8B, in a case of topology 2, an intermediate node 420 is present between the ambient IoT device 300 and the base station 410. That is, in the case of topology 2, the ambient IoT device 300 bidirectionally communicates with the intermediate node 420. The intermediate node 420 may be the communication node 400. That is, the intermediate node 420 may be any one of the gNB 200, the UE 100, a relay node, an IAB node, or an NCR. The intermediate node 420 transfers data relating to the ambient IoT device 300 and/or signaling relating to the ambient IoT device 300 between the base station 410 and the ambient IoT device 300. As for topology 2, an example where the communication node 400 is the intermediate node 420 is described.

### (A3) Topology 3

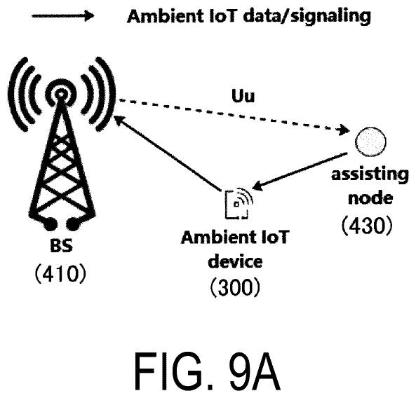

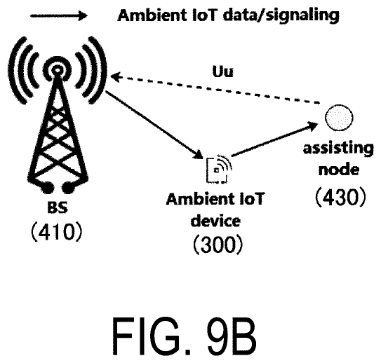

FIGS. 9A and 9B are diagrams illustrating a configuration example of topology 3 according to the first embodiment. In a case of topology 3, communication is performed via a node called an assisting node 430. That is, as illustrated in FIG. 9A, the ambient IoT device 300 transmits data and/or signaling to the base station 410, and receives data and/or signaling from the assisting node 430. In FIG. 9A, the assisting node 430 may perform CW transmission, and the base station 410 may perform BS reception. FIG. 9A illustrates communication in a downstream direction.

As illustrated in FIG. 9B, the ambient IoT device 300 receives data and/or signaling from the base station 410, and transmits data and/or signaling to the assisting node 430. In FIG. 9B, the base station 410 may perform CW transmission, and the assisting node 430 may perform BS reception. FIG. 9B illustrates communication in an upstream direction.

As described above, in the case of topology 3, the assisting node 430 may be a node that performs CW transmission but does not perform BS reception (FIG. 9A). In the case of topology 3, the assisting node 430 may be a node that does not perform CW transmission but performs BS reception (FIG. 9B). That is, the assisting node 430 may be a node that performs any one of the CW transmission or the BS reception. As for topology 3, an example where the assisting node 430 is the communication node 400 is described. The assisting node 430 may be any one of the gNB 200, the UE 100, the relay node, the IAB node, or the NCR.

### (A4) Topology 4

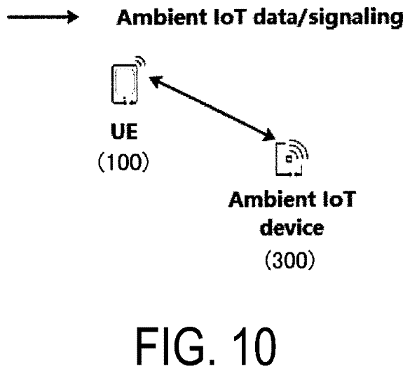

FIG. 10 is a diagram illustrating a configuration example of topology 4 according to the first embodiment. In a case of topology 4, the ambient IoT device 300 bidirectionally communicates with the UE 100. Data and/or signaling are transferred between the UE 100 and the ambient IoT device 300. As for topology 4, an example where the communication node 400 is the UE 100 is described.

### Multiple Access Method for Ambient IoT Device

The wireless communication system 1 including the ambient IoT devices 300 assumes that a very large number of the ambient IoT devices 300 are connected to the wireless communication system 1. In this case, when the ambient IoT devices 300 simultaneously perform BS transmission using frequencies that are entirely the same, interference occurs. Hence, the communication node 400 on the reception side may not be able to normally receive the reflected wave transmitted from the ambient IoT device 300.

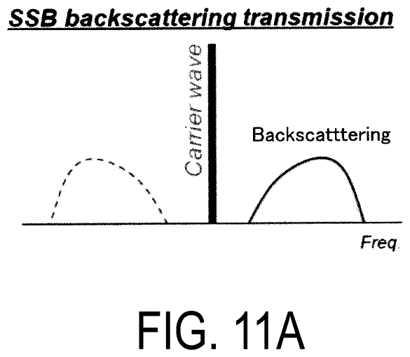

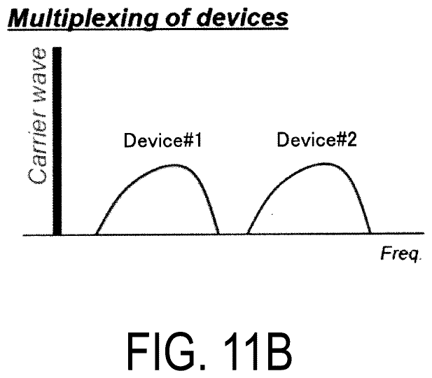

FIGS. 11A and 11B are diagrams illustrating an example of the multiple access method according to the first embodiment.

As illustrated in FIG. 11A, for BS transmission, a transmission scheme using single sideband (SSB) transmission may be used. SSB is a scheme of removing a sideband of one side at a time of amplitude modulation and performing transmission using a sideband of a remaining other side. In the case of amplitude modulation, a frequency component includes two sidebands (a Low Side Band (LSB) and an Upper Side Band (USB)) that are symmetrical with respect to the carrier wave used for CW transmission, but a sideband of one side (the low side band is removed and the upper side band is used in FIG. 11A) is used for the SSB. Accordingly, SSB can reduce transmission power of the ambient IoT device 300 and can increase the frequency efficiency compared to the case of using dual sidebands. By estimating a missing sideband from a position of the carrier wave used for CW transmission, the communication node 400 on the receiving side can process the missing side band similarly to the case of the dual sidebands. SSB may be executed by, for example, a known configuration. By, for example, inputting a carrier wave and a signal wave to a balanced modulator, performing balanced modulation on the carrier wave with the signal wave, and then removing an unnecessary sideband using a Band Pass Filter (BPF), transmission can be performed using SSB. Such a component may be provided in, for example, the controller 330. Note that a transmission scheme that uses dual sidebands will be referred to as dual sideband (DSB).

As illustrated in FIG. 11B, when a plurality of the ambient IoT devices 300 simultaneously performs BS transmission using SSB, the BS transmission is performed using different frequencies. Thus, even when the plurality of ambient IoT devices 300 simultaneously performs the BS transmission using SSB, interference can be avoided and the communication node 400 can normally perform the BS reception.

### Protocol Stack

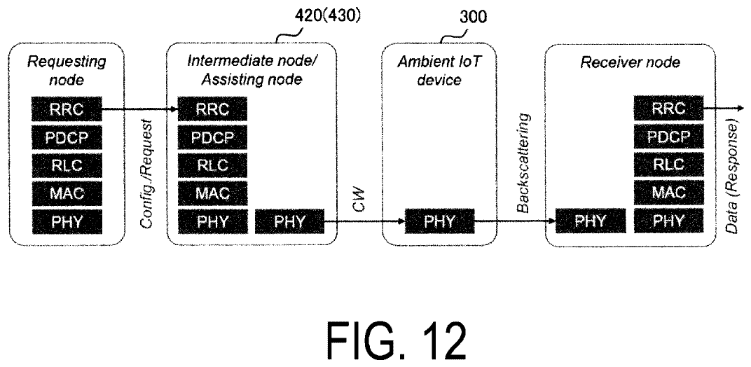

FIG. 12 is a diagram illustrating a configuration example of a protocol stack in the wireless communication system 1 including the ambient IoT devices.

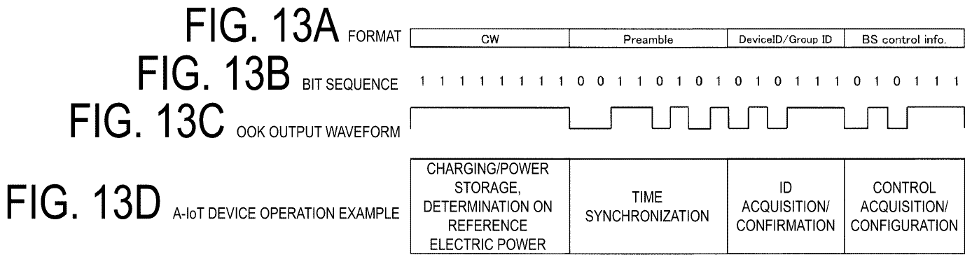

In the example illustrated in FIG. 12, a requesting node transmits a configuration and/or a request relating to communication with the ambient IoT device 300 to the intermediate node 420 (or the assisting node 430) using an RRC message. The physical layer (PHY) performs CW transmission and BS transmission, and a receiver node transmits data (or a response message) received through the BS transmission using the RRC message. FIG. 13 illustrates an example where the requesting node and the receiver node are the gNBs 200, and the intermediate node 420 (or the assisting node 430) is the UE 100. Although communication with the ambient IoT device 300 is performed in the PHY layer, a protocol stack different from that in FIG. 13 may be used depending on a combination of the type of an entity in the requesting node and the receiver node and the type of an entity in the intermediate node 420 or the assisting node 430.

### Communication Control Method According to First Embodiment

Communication in the ambient IoT device 300 is performed by transmitting an unmodulated carrier wave from the communication node 400 to the ambient IoT device 300, and transmitting a reflected wave of the carrier wave from the ambient IoT device 300 to the communication node 400.

On the other hand, an apparatus on the network side may want to control communication in the ambient IoT device 300. For example, the apparatus on the network side may want to individually control communication with a plurality of the ambient IoT devices 300. The apparatus on the network side may also group the ambient IoT devices 300 and control the ambient IoT devices 300 per group. If the apparatus on the network side can control communication with the ambient IoT device 300, communication supporting various use cases can be performed.

Hence, the first embodiment enables the apparatus on the network side to appropriately control communication in the ambient IoT device 300.

Hence, in the first embodiment, first, a communication node (e.g., communication node 400) transmits at least one selected from the group consisting of a first unmodulated signal, a preamble signal, a signal representing identifier information of an IoT device (e.g., ambient IoT device 300), and a signal representing control information relating to backscattering transmission as a transmission signal to the IoT device. Second, the IoT device receives the transmission signal. Third, the communication node transmits a second unmodulated signal. Fourth, the IoT device performs backscattering transmission on the second unmodulated signal using the transmission signal.

As described above, in the first embodiment, the communication node 400 transmits the transmission signal to the ambient IoT device 300, and the ambient IoT device 300 performs BS transmission using the transmission signal. Thus, for example, the communication node 400 can control communication with the ambient IoT device using the control information. Accordingly, the apparatus on the network side can appropriately control communication in the ambient IoT device.

Note that the communication node 400 is an example of the apparatus on the network side. That is, the apparatus on the network side may be any one of the UE 100, the gNB 200, the intermediate node, and the assisting node.

The transmission signal to be transmitted by the communication node 400 may be referred to as a “DL (Down Link) command” below. After transmitting the DL command, the communication node 400 performs CW transmission and receive BS transmission from the ambient IoT device 300. After transmitting the DL command, the communication node 400 may receive the BS transmission from the ambient IoT device 300 for the CW transmission performed by another communication node. The DL command may be a control command or a control signal.

### Signal Format of DL Command

As described above, the DL command is at least one selected from the group consisting of the first unmodulated signal, the preamble signal, the signal representing the identifier information of the ambient IoT device 300, and the signal representing the control information relating to the BS transmission.

A specific example of the DL command according to the first embodiment will be described.

FIGS. 13A to 13D are diagrams illustrating examples of signal formats of the DL command according to the first embodiment. The DL commands illustrated in FIGS. 13A to 13D represent signal format examples in a case where all of the first unmodulated signal, the preamble signal, the signal representing the identifier information of the ambient IoT device 300, and the signal representing the control information relating to the backscattering transmission are transmitted.

As illustrated in FIG. 13A, the DL command includes a CW portion for transmitting the first unmodulated signal, a preamble portion for transmitting a preamble signal, a device/group ID portion for transmitting a signal representing the identifier information of the ambient IoT device 300, and a BS control information portion for transmitting a signal representing the control information relating to the BS transmission.

### (A1) CW Portion

The first unmodulated signal to be transmitted in the CW portion may be represented by a signal sequence in which bit sequences “1” are continuously arranged. For example, in a case of On-Off-keying (OOK), a bit sequences “1” represents the presence of a carrier wave, and a bit sequence “0” represents the absence of a carrier wave. Hence, the communication node 400 can transmit a carrier wave of an unmodulated signal by using the bit sequence “1”. In a case of, for example, Amplitude-Shift-Keying (ASK), a bit sequence “1” represents a large amplitude, and a bit sequence “0” represents a small amplitude. Hence, by using the bit sequence “1”, the communication node 400 can transmit the carrier wave of the unmodulated signal more reliably than in the case of the bit sequence “0”. FIG. 13C illustrates an example of an output waveform in the case of OOK, for example.

Note that the first unmodulated signal to be transmitted in the CW portion may be used to determine reference electric power in the ambient IoT device 300. Specifically, the first unmodulated signal may be used in the ambient IoT device 300 to determine reception electric power of the CW (the CW of the second unmodulated signal) used when BS transmission is performed. For example, the controller 330 of the ambient IoT device 300 may perform the following processing.

That is, the controller 330 holds in the memory 340 the reception electric power of the first unmodulated signal to be transmitted in the CW portion as the reference electric power. When the reception electric power of the reception signal is the reference electric power or more, the controller 330 then determines that the reception signal is a reception signal of CW transmission (CW transmission of the second unmodulated signal), and performs BS transmission. On the other hand, when the reception electric power of the reception signal is less than the reference electric power, the controller 330 determines that the reception signal is not a reception signal of CW transmission and does not perform BS transmission. Note that the reference electric power may be electric power lower than the reception electric power. For example, a value obtained by multiplying ½ on the reception electric power may be set to the reference electric power. The reception electric power and the reference electric power may be a reception voltage and a reference voltage, respectively, may be a reception current and a reference current, respectively, or may be a reception electric field strength and a reference electric field strength, respectively.

As described above, the ambient IoT device 300 uses the first unmodulated signal as the reference electric power for the second unmodulated signal, so that it can be said that the ambient IoT device 300 uses the first unmodulated signal for the BS transmission.

The first unmodulated signal to be transmitted in the CW portion may be used for power storage (or charging) in the ambient IoT device 300. If the ambient IoT device 300 has a power storage function, the controller 330 of the ambient IoT device 300 can convert the unmodulated signal into electric power by the above-described energy conversion function, and store (or charge) the electric power in a power storage (or a charger).

### (A2) Preamble Portion

A preamble signal to be transmitted in a preamble portion is represented by a known bit pattern in the ambient IoT device 300 by, for example, being defined in a specification.

Note that the preamble signal may be used for time synchronization in the ambient IoT device 300. For example, the controller 330 of the ambient IoT device 300 can establish temporal synchronization with the communication node 400 (or the network) by devising a time synchronization timing using the preamble signal. As described above, the ambient IoT device 300 can implement time synchronization with the communication node 400 using the preamble signal, and then perform BS transmission for CW transmission from the communication node 400 in a situation where the time synchronization is implemented, so that it can be said that the ambient IoT device 300 performs BS transmission using the preamble signal. Note that the temporal synchronization may refer to synchronization of an operation clock of the ambient IoT device 300 with the communication node 400 (or the network).

### (A3) Device ID/Group ID Portion

The identifier information of the ambient IoT device 300 to be transmitted in the device ID/group ID portion may be information for designating the ambient IoT device 300 that performs BS transmission. Thus, for example, the communication node 400 (or the network apparatus) can designate execution of BS transmission for the specific ambient IoT device 300 among a plurality of ambient IoT devices 300.

The identifier information may indicate a group of ambient IoT devices. The identifier information indicates the group, so that the communication node 400 (or the network apparatus) can designate execution of the BS transmission for a specific group.

The identifier information may be used to invoke the specific ambient IoT device 300 from the communication node 400 (or the network) side. Note that the identifier information may be written in advance (e.g., at a time of shipping from a factory) in the memory 340 of the ambient IoT device 300. By comparing the identifier information received from the communication node 400 (or the network apparatus), and the identifier information stored in the memory 340, the ambient IoT device 300 may determine whether execution of BS transmission has been designated.

### (A4) BS Control Information Portion

The control information to be transmitted in the BS control information portion (that may be referred to as “BS control information” hereinafter) may include at least one selected from the group consisting of transmission mode information, the frequency information, the communication timing information, and the communication mode information.

### (A4-1) Mode Information

The mode information indicates either active transmission of performing transmission using an internal power supply, or passive transmission of performing transmission using a reception wave as a power supply. The active transmission corresponds to, for example, transmission performed by the UE 100 that uses the internal power supply. On the other hand, the passive transmission corresponds to, for example, BS transmission performed by the ambient IoT device 300.
(a4-2) Frequency Information
The frequency information indicates information relating to a frequency used for BS transmission. Bit patterns and frequency patterns are associated with each other in advance for the frequency information, and the frequency information is designated by one of the bit patterns. For example, a bit pattern “00” may represent a frequency pattern A, a bit pattern “01” may represent a frequency pattern B, a bit pattern “10” may represent a frequency pattern C, and a bit pattern “11” may represent a frequency pattern D.

The frequency patterns may directly represent transmission frequencies. For example, the frequency pattern A represents a transmission frequency f1, and the frequency pattern B represents a transmission frequency f2.

The frequency pattern may be represented by a mistuned frequency indicating how much the frequency used for BS transmission is apart from the frequency used for CW transmission. According to, for example, the frequency pattern A, a frequency (or a frequency band) that is apart by a mistuned frequency “x” from the frequency used for CW transmission is used for BS transmission, and, according to the frequency pattern B, a frequency (or a frequency band) that is apart by a mistuned frequency “y” from the frequency used for CW transmission is used for BS transmission (e.g., FIG. 11B). The mistuned frequency may be determined according to a combination of the frequency pattern and the identifier information of the ambient IoT device 300. According to, for example, a combination of the frequency pattern A (a frequency that is apart by the mistuned frequency “x” from the transmission frequency for CW transmission) and the identifier information of the ambient IoT device 300, a frequency (or a frequency band) at the mistuned frequency “z” is used for BS transmission. As described above, the frequency to be used for BS transmission can be determined for each ambient IoT device 300 according to the combination of the mistuned frequency and the identifier information of the ambient IoT device 300. Determination of the combination may be performed using a table. The determination may be performed using a calculation formula.

### (A4-3) Communication Timing Information

The communication timing information indicates the communication timing of BS transmission. BS transmission in the ambient IoT device 300 is performed at a transmission timing of CW transmission (transmission of the second unmodulated signal) from the communication node 400. Hence, it can be said that the communication timing of the BS transmission represents a timing to perform the CW transmission at the communication node 400. That is, the communication timing information may indicate a timing to perform the CW transmission.

As for the communication timing information, bit patterns representing the communication timing information, and transmission patterns are associated with each other in advance, and the communication timing information is represented by one of the bit patterns. For example, the bit patterns and the transmission patterns may be associated as follows. That is, the bit pattern “00” represents a transmission pattern for performing CW transmission that starts immediately after the DL command and is performed in one radio frame period. The bit pattern “01” represents a transmission pattern for performing CW transmission that starts immediately after the DL command and is performed in a 10-radio frame period. The bit pattern “10” represents a transmission pattern for performing CW transmission that starts after one radio frame of the DL command and is performed in one radio frame period. The bit pattern “11” represents a transmission pattern for performing CW transmission that starts after 10 radio frames of the DL command and is performed in a 10-radio frame period.

Note that, in the above-described example, the “radio frame” may be replaced with a “subframe”, a “slot”, or a “symbol”.

In the above-described example, “CW transmission” may be replaced with “data reception”. The ambient IoT device 300 may also be able to perform data writing. Hence, data writing may be designated by a communication mode described below, and a timing of “data reception” (that is, a timing of data writing) may be indicated by the communication timing information.

### (A4-4) Communication Mode Information

The communication mode information indicates a communication mode of the ambient IoT device 300. Specifically, the communication mode information may be information indicating a writing mode of performing writing in the ambient IoT device 300. The communication mode information may be information indicating a specific type of BS transmission at a time when the BS transmission is performed in the ambient IoT device 300.

Bit patterns representing the communication mode information and the communication mode information are associated with each other in advance, and the communication mode information may be represented by one of the bit patterns. For example, the bit patterns and the communication mode information may be associated as follows.

That is, a bit pattern “000” represents a communication mode of transmitting, through BS transmission, all data accumulated in the memory 340 of the ambient IoT device 300.

A bit pattern “001” represents a communication mode of transmitting, through BS transmission, a part of data accumulated in the memory 340 of the ambient IoT device 300. The part of data may mean transmitting a maximum amount of data that can be transmitted through the BS transmission in order from the new data.

A bit pattern “010” represents an existence confirmation mode. The existence confirmation mode represents, for example, a communication mode of confirming whether the ambient IoT device 300 can perform BS transmission. At a time of the existence confirmation mode, the ambient IoT device 300 may transmit own identifier information held in the memory 340 through BS transmission.

A bit pattern “011” represents a Device-Originated (DO) data presence/absence confirmation mode. The DO data presence/absence confirmation mode represents, for example, a communication mode of confirming whether there is data to be transmitted through BS transmission in the ambient IoT device 300. At the time of the DO data presence/absence confirmation mode, the ambient IoT device 300 may indicate that there is data through BS transmission, by transmitting the own the identifier information through the BS transmission. The ambient IoT device 300 may indicate that there is no data through the BS transmission, by not transmitting the own identifier information through the BS transmission.

A bit pattern “100” represents a communication mode of writing data in the memory 340 of the ambient IoT device 300. In this case, the communication node 400 may transmit data for writing after the DL command.

Note that the writing mode can be considered to be a different mode from that of BS transmission. Hence, it can be said that the ambient IoT device 300 performs the BS transmission using a part of BS control information.

The signal format examples of the DL command have been described above.

### Operation Example According to First Embodiment

Next, an operation example where a DL command is used will be described.

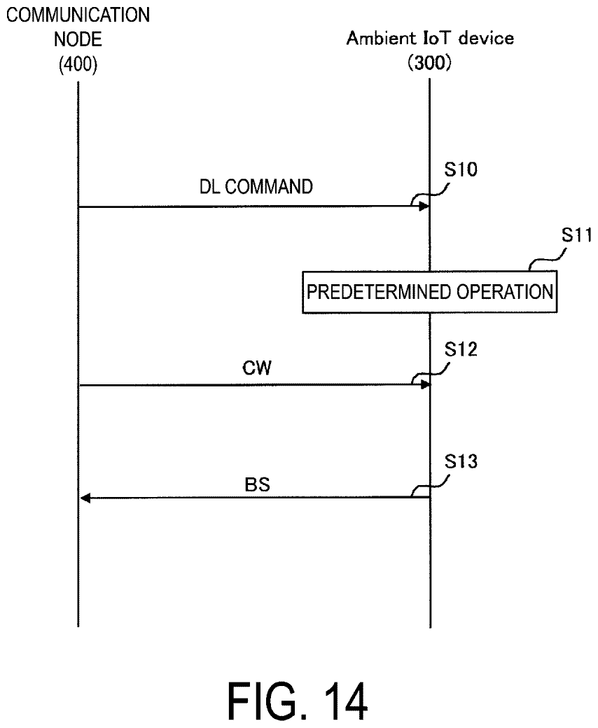

FIG. 14 is a diagram illustrating the operation example according to the first embodiment.

As illustrated in FIG. 14, in step S10, a transmitter of the communication node 400 transmits a DL command. If the communication node 400 is the UE 100, the transmitter 120 of the UE 100 transmits the DL command. If the communication node 400 is the gNB 200, the transmitter 210 of the gNB 200 transmits the DL command. The controller 330 of the ambient IoT device 300 receives the DL command. The DL command may be included in DCI of the PHY layer and transmitted. The DL command may be transmitted on a physical channel (or a signal waveform) newly created for communication with the ambient IoT device 300 in the PHY layer. The DL command may be included in a message of a new layer newly created for communication with the ambient IoT device 300 and transmitted.

In step S11, the ambient IoT device 300 performs a predetermined operation. Processing performed on the DL command by the ambient IoT device 300 may be the predetermined operation. Details of the predetermined operation will be described in the second embodiment.

In step S12, the transmitter of the communication node 400 performs CW transmission. If the communication node 400 is the UE 100, the transmitter 120 of the UE 100 performs CW transmission. If the communication node 400 is the gNB 200, the transmitter 210 of the gNB 200 performs CW transmission. The transmitter of the communication node 400 may perform CW transmission according to the DL command.

In step S13, the ambient IoT device 300 performs BS transmission for CW transmission. The controller 330 of the ambient IoT device 300 performs BS transmission according to the DL command. The BS transmission in step S13 will also be described in the second embodiment. A receiver of the communication node 400 receives BS transmission from the ambient IoT device 300, and receives data and the like transmitted through the BS transmission. If the communication node 400 is the UE 100, the receiver 110 of the UE 100 performs reception processing for the BS transmission. If the communication node 400 is the gNB 200, the receiver 220 of the gNB 200 performs reception processing for the BS transmission.

### Other Operation Example 1 According to First Embodiment

In the first embodiment, as for the signal format of the DL command illustrated in FIG. 13A, an example in which the CW portion, the preamble portion, the device/group ID portion, and the BS control information portion are transmitted in this order has been described. In the DL command, the CW portion, the preamble portion, the device/group ID portion, and the BS control information portion may be transmitted in random order. For example, transmission may be performed in order of the CW portion at the head, then the preamble portion, then the BS control information portion, and the device/group ID portion at the tail.

### Second Embodiment

The second embodiment will be described. Differences from the first embodiment will be mainly described in the second embodiment.

The example of the operation of transmitting the DL command by the communication node 400 has been described in the first embodiment. An example of an operation of receiving the DL command by the ambient IoT device 300 will be described in the second embodiment.

Specifically, first, the IoT device (e.g., ambient IoT device 300) receives at least one selected from the group consisting of a first unmodulated signal, a preamble signal, a signal representing identifier information of an IoT device, and a signal representing control information relating to backscattering transmission as a reception signal (e.g., DL command) from the communication node (e.g., communication node 400). Second, the IoT device performs backscattering transmission on a second unmodulated signal transmitted from the communication node using the reception signal.

As described above, in the second embodiment, the ambient IoT device 300 can perform BS transmission using the DL command. Hence, an apparatus on the network side can control the BS transmission in the ambient IoT device 300 using the DL command. Accordingly, also in the second embodiment, the apparatus on the network side can appropriately control communication in the ambient IoT device 300.

### Operation Example According to Second Embodiment

The operation example according to the second embodiment will be described.

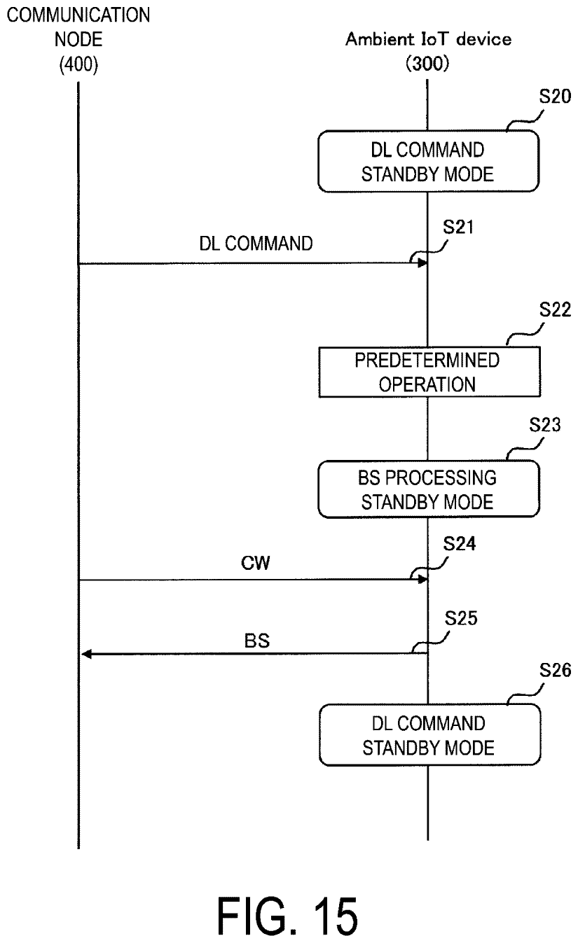

FIG. 15 is a diagram illustrating the operation example according to the second embodiment.

As illustrated in FIG. 15, in step S20, the controller 330 of the ambient IoT devices 300 enters a DL command standby mode.

First, the DL command standby mode may be a power saving mode (or a no electric power mode) of detecting a DL command and not detecting other signals. The DL command standby mode may be a state in which the modulator 320 is not operating, either. The DL command standby mode may be a state in which the modulator 320 does not demodulate the DL command, and the controller 330 (or the antenna 310) monitors reception electric power (or the reception voltage).

Second, the DL command standby mode may be a state for standing by for a specific DL command. For example, the DL command standby mode may be a state for standing by for (the first unmodulated signal of) the DL command. Hence, for example, the controller 330 may monitor whether the reception electric power (or the reception voltage) is a threshold value or more.

In step S21, the transmitter of the communication node 400 transmits the DL command. The controller 330 of the ambient IoT device 300 receives the DL command.

In step S22, the controller 330 of the ambient IoT device 300 performs a predetermined operation in response to reception of the DL command. Specific examples of the predetermined operation will be described below.

### (B1) Case Where DL Command is First Unmodulated Signal

When detecting “1” (continuously) for an output from the modulator 320, the controller 330 of the ambient IoT device 300 determines that the first unmodulated signal in the DL command has been detected (or the DL command has been detected as the first unmodulated signal). When detecting the first unmodulated signal, the controller 330 may perform at least one selected from the group consisting of the followings as the predetermined operation.

First, when detecting the first unmodulated signal, the controller 330 may determine reference electric power (or a reference voltage) using the first unmodulated signal. Specifically, the controller 330 may determine reception electric power (or a reception voltage) of the first unmodulated signal as the reference electric power (or the reference voltage) for determining whether a CW (second unmodulated signal) used when performing BS transmission has been received. The controller 330 may specify a threshold value for determining whether a symbol point corresponding to the CW (second unmodulated signal) has been received, based on a symbol point corresponding to a preamble signal.

Second, when detecting the first unmodulated signal, the controller 330 may perform a power generation operation based on the first unmodulated signal. The controller 330 may perform the power generation operation using the power generation function of the ambient IoT device 300. The controller 330 may perform a charging operation (or a power storage operation) based on the first unmodulated signal as the predetermined operation. The controller 330 may perform the power generation operation (or the power storage operation) using a charging function (or the power storage function) of the ambient IoT device 300.

Third, when detecting the first unmodulated signal, the controller 330 may start standing by for a next signal (e.g., preamble signal) of the first unmodulated signal.

### (B2) Case Where DL Command is Preamble Signal

When detecting the preamble signal, the controller 330 may perform at least one selected from the group consisting of the followings as the predetermined operation.

First, the controller 330 may perform time synchronization (or timing synchronization) using the preamble signal. The controller 330 may perform clock synchronization that uses the preamble signal as a standard clock.

Second, the controller 330 may determine reference electric power (or a reference voltage) using the preamble signal. Similarly to the case where the DL command is the first unmodulated signal, the controller 330 may determine using the preamble signal the reference electric power for determining whether the CW (second unmodulated signal) used when performing BS transmission has been received. The controller 330 may determine the threshold value for determining whether a symbol point has been received.

Third, the controller 330 may start standing by for a next signal (e.g., a signal to be transmitted as a device ID/group ID portion) of the preamble signal.

### (B3) Case Where DL Command is Signal to be Transmitted as Device ID/Group ID Portion

When detecting a signal transmitted as the device ID/group ID portion, the controller 330 may perform at least one selected from the group consisting of the followings as the predetermined operation.

First, the controller 330 may confirm whether identifier information included in the signal matches with the identifier information of the ambient IoT device 300 (or identifier information of a group to which the ambient IoT device 300 belongs). The controller 330 reads the own identifier information from the memory 340, and compares the own identifier information with the identifier information included in the DL command. If the identifier information included in the DL command and the own identifier information match, the controller 330 may perform the following operation. On the other hand, if the identifier information included in the DL command and the own identifier information do not match, the controller 330 may stop subsequent processing (or continue the DL command standby mode).

Second, the controller 330 may start standing by for a next signal (e.g., a signal to be transmitted as a BS control information portion) of the signal to be transmitted as the device ID/group ID portion.

### (b4) Case Where DL Command is Signal to be Transmitted as BS Control Information Portion

When detecting a signal transmitted as the BS control information portion, the controller 330 may perform at least one selected from the group consisting of the followings as the predetermined operation.

First, if the BS control information includes the mode information ((A4-1) in the first embodiment), the controller 330 determines whether to perform active transmission or perform passive transmission according to the mode information. The controller 330 performs either active transmission or passive transmission at a transmission timing (step S25 at a subsequent stage). Note that description will be continued below assuming that the controller 330 performs passive transmission (that is, BS transmission).

Second, if the BS control information includes the frequency information ((A4-2) in the first embodiment), the controller 330 determines a frequency used for BS transmission using the frequency information. For example, detailed information of the frequency pattern (e.g., a frequency pattern associated with a bit pattern) is stored in the memory 340. Hence, by confirming the detailed information and specifying a frequency pattern (e.g., frequency pattern B) that matches with a bit pattern (e.g., “01”) included in the frequency information, the controller 330 may determine a frequency used for BS transmission (e.g., a transmission frequency used in the frequency pattern B is f2, or a frequency that is apart by the mistuned frequency “y” from the frequency used for CW transmission in the frequency pattern B is used as the transmission frequency). The controller 330 may specify the mistuned frequency for the frequency used for CW transmission from the combination of the own identifier information and the frequency pattern, and determine the frequency used for BS transmission using the frequency. The controller 330 performs BS transmission using the determined frequency (step S25 at the subsequent stage).

Third, if the BS control information includes the communication timing information, the controller 330 determines a time for performing BS transmission. For example, detailed information of the communication timing information (e.g., a transmission pattern associated with a bit pattern representing the communication timing information) is stored in the memory 340. Hence, by specifying the transmission pattern associated with the bit pattern (e.g., “00”) included in the communication timing information (e.g., a transmission pattern of performing CW transmission that starts immediately after the DL command and is performed in one radio frame period), the controller 330 may determine the time for performing BS transmission.

If, for example, the bit pattern included in the communication timing information is “01”, the controller 330 may determine to perform BS transmission during the 10-radio frame period starting immediately after reception of the DL command.

If the bit pattern included in the communication timing information is “10”, the controller 330 may determine to start BS transmission after one radio frame and perform BS transmission in one radio frame period.

If the bit pattern of the communication timing information is “11”, the controller 330 may determine to start after one radio frame, and perform BS transmission in a 10-radio frame period. The controller 330 performs BS transmission at the determined time (step S25 at the subsequent stage).

Fourth, if the BS control information includes communication mode information, the controller 330 may determine contents of information to be transmitted through the BS transmission, based on the communication mode information. For example, the detailed information of the communication mode information (e.g., a communication mode associated with a bit pattern representing the communication mode information) is stored in the memory 340. Hence, by specifying the communication mode associated with the bit pattern (e.g., “000”) included in the communication mode information (e.g., the communication mode of transmitting all the data stored in the memory 340 through BS transmission), the controller 330 may determine the contents of the information to be transmitted through the BS transmission according to the communication mode.

If, for example, the bit pattern representing the communication mode information is “001”, the controller 330 may read a maximum amount of data that can be transmitted through BS transmission from the memory 340 in order from the latest data among data accumulated in the memory 340, and use the data as the contents of the information to be transmitted through BS transmission.

If the bit pattern representing the communication mode information is “010”, the controller 330 may read the own identifier information from the memory 340 assuming the communication mode of the existence confirmation mode, and determine the identifier information as the contents of the information to be transmitted through the BS transmission.

If the bit pattern representing the communication mode information is “011”, the controller 330 confirms whether the data that needs to be transmitted through BS transmission is present in the memory 340 assuming the communication mode of the DO data presence/absence confirmation mode. If the data that needs to be transmitted through BS transmission is present in the memory 340, the own identifier information stored in the memory 340 may be the contents of the information to be transmitted through BS transmission. On the other hand, if the data that needs to be transmitted through BS transmission is present in the memory 340, there may be no information to be transmitted through BS transmission. The controller 330 transmits information of the determined contents through BS transmission (step S25 at the subsequent stage).

Note that, as described in the first embodiment, instead of BS transmission, the writing mode may also be included as the communication mode information. If the writing mode (e.g., “100”) is designated as the communication mode, the controller 330 transitions to the writing mode without performing BS transmission (without transitioning to a “BS processing standby mode” described below), and waits for reception of data for writing to be transmitted from the communication node 400.

Fifth, the controller 330 may start standing by for a next signal (e.g., the second unmodulated signal (CW) or a signal for write data) of the signal to be transmitted as the BS control information portion. Note that description will be given below assuming that the controller 330 stands by for a CW for performing BS transmission, that is, transitions to a mode of performing BS transmission according to the communication mode information. The mode of performing BS transmission will be referred to as a “BS processing standby mode” hereinafter.

In step S23, the controller 330 of the ambient IoT devices 300 transitions to the BS processing standby processing mode. Specifically, the controller 330 stands by for the CW (second unmodulated signal) for BS transmission (reflection of CW transmission).

In step S24, the communication node 400 performs CW transmission.

First, a signal to be transmitted from the communication node 400 for BS transmission may include a preamble signal and the CW (second unmodulated signal). In this case, the controller 330 of the ambient IoT device 300 may perform time synchronization using the preamble signal. An operation of the modulator 320 may be started at a timing of the CW after the preamble signal. A signal including the preamble signal and the CW may be a DL command.

Second, the signal to be transmitted from the communication node 400 for BS transmission may be only the CW (second unmodulated signal). At a transmission timing of the CW, the operation of the modulator 320 in the ambient IoT device 300 may be started.

In step S25, the ambient IoT device 300 performs BS transmission. The controller 330 of the ambient IoT device 300 performs BS transmission according to the BS control information. Specifically, the controller 330 performs BS transmission according to the frequency information and/or the communication timing information included in the BS control information. The controller 330 performs BS transmission according to communication mode information included in the BS control information. Specifically, in a case of the communication mode of transmitting all data through BS transmission, the controller 330 transmits all the data accumulated in the memory 340 through the BS transmission. In the case of the communication mode of transmitting a part of the data through BS transmission, the controller 330 transmits through the BS transmission the maximum amount of the data that can be transmitted through the BS transmission in order from the latest data stored in the memory 340. In the case of the communication mode of the existence confirmation mode, when confirming the own existence, the controller 330 transmits the own identifier information stored in the memory 340 through the BS transmission. In the case of the communication mode of the DO data presence/absence confirmation mode, if data transmitted through BS transmission is present in the memory 340, the controller 330 transmits the own identifier information stored in the memory 340 through the BS transmission. On the other hand, in the case of the communication mode of the DO data presence/absence confirmation mode, if the data transmitted through the BS transmission is not present in the memory 340, the controller 330 does not transmit the own identifier information through the BS transmission, and does not need to process CW transmission in particular.

In step S26, the controller 330 of the ambient IoT devices 300 transitions to the DL command standby mode again. The controller 330 may transition to the DL command standby mode at a point of time at which the BS transmission (step S25) ends. When transitioning to the DL command standby mode, the ambient IoT device 300 may repeat the processing in and after step S21.

### Third Embodiment

The third embodiment will be described.

In the first embodiment, an example in which the communication node 400 transmits the DL command has been described. In the third embodiment, an example in which a network apparatus (e.g., gNB 200) controls what kind of a DL command the communication node 400 transmits at what timing will be described.

Specifically, first, the network apparatus (e.g., gNB 200) transmits configuration information to a communication node (e.g., communication node 400). Second, the communication node transmits a transmission signal (e.g., DL command) to an IoT device (e.g., ambient IoT device 300) based on the configuration information. Here, similarly to the first embodiment, the transmission signal represents at least one selected from the group consisting of a first unmodulated signal, a preamble signal, a signal representing identifier information of the IoT device, and a signal representing control information relating to backscattering transmission.

Thus, for example, the network apparatus can control the contents of the DL command transmitted by the communication node 400 or control the transmission timing of the DL command using the configuration information. Hence, the network apparatus can appropriately control communication in the ambient IoT device 300.

### Operation Example According to Third Embodiment

An operation example according to the third embodiment will be described.

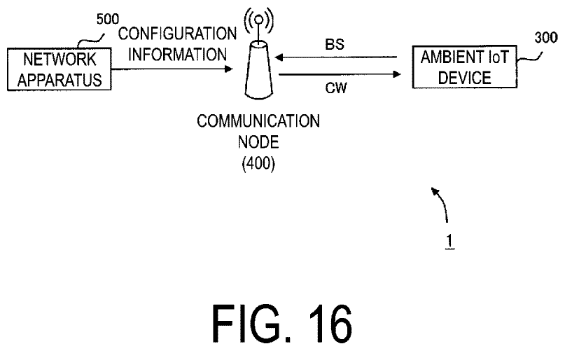

FIG. 16 is a diagram illustrating a communication example according to the third embodiment. As illustrated in FIG. 16, a network apparatus 500 transmits configuration information to the communication node 400.

The network apparatus 500 may be the gNB 200. The network apparatus 500 may be a device or an entity (that may be referred to as a “core network apparatus” below) connected to the core network 20. The core network apparatus may be the AMF 30, an SMF, or the like. The description will be given below assuming the gNB 200 as an example of the network apparatus 500.

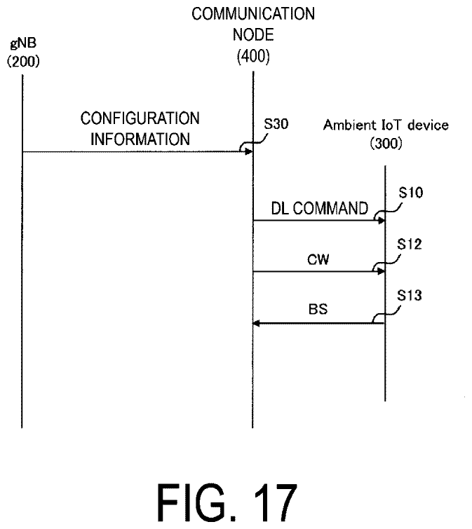

FIG. 17 is a diagram illustrating the operation example according to the third embodiment.

As illustrated in FIG. 17, in step S30, the transmitter 210 of the gNB 200 transmits the configuration information relating to the DL command to the communication node 400.

First, the configuration information basically includes information included in the DL command. Specifically, the configuration information may include identifier information of the ambient IoT device 300 and/or control information relating to BS transmission. The configuration information may include information indicating which of the first unmodulated signal, the preamble signal, the signal representing the identifier information of the IoT device, and the signal representing the control information relating to backscattering transmission is transmitted as the DL command.

Second, as for the configuration information, a plurality of pieces of configuration information may be expressed in a list format. Each of the plurality of pieces of configuration information may have a configuration ID. An index may be indicated in the order of entries of the plurality of pieces of configuration information expressed in the list format, and each configuration information may be identified based on the index.

Third, the configuration information may include information for specifying a timing at which the communication node 400 transmits the DL command. For example, the information may include a radio frame number of a start radio frame in which transmission of the DL command is started. The information may include a cycle at which the DL command is repeatedly transmitted. The configuration information may include information indicating whether to periodically (periodic transmission) transmit the DL command or aperiodically (aperiodic transmission) transmit the DL command.

When the DL command is periodically transmitted, an indication (or a notification) for activating one or more pieces of configuration information among the plurality of pieces of configuration information may be included in the configuration information. The indication may be indicated by the above-described configuration ID. The indication may be indicated by the above-described index. As for the DL command including the activated configuration information, the communication node 400 transmits the DL command at a timing designated by the configuration information. When the DL command is periodically transmitted, an indication (or a notification) for deactivating the one or more pieces of configuration information among the plurality of pieces of configuration information may be included in the configuration information. The indication may also be indicated by the configuration ID or the index. The communication node 400 stops transmitting the DL command including the deactivated configuration information.

When the DL command is aperiodically transmitted, indication information for indicating to transmit the DL command according to the configuration information may be included in the configuration information. The indication information may include a configuration ID of the configuration information that is an indication target. The indication information may include the above-described index of the configuration information that is the indication target. As soon as receiving the configuration information including the indication information, the communication node 400 may immediately transmit the DL command to the ambient IoT device 300 only once. The configuration information may include information indicating the timing to transmit the DL command, and, in this case, the communication node 400 transmits the DL command only once at the timing. The information indicating the timing may indicate a waiting time in the communication node 400 after receiving the configuration information.

Fourth, if the communication node 400 is the UE 100, the transmitter 210 of the gNB 200 may transmit the configuration information by transmitting an RRC message including the configuration information. If the communication node 400 is a gNB (in this case, for example, the gNB 200 is a gNB #1 and the gNB that is the communication node 400 is a gNB #2), the transmitter 210 of the gNB 200 (gNB #1) may transmit the configuration information by transmitting an Xn-AP message including the configuration information to the gNB (gNB #2). If the communication node 400 is an IAB node, the transmitter 210 of the gNB 200 may transmit the configuration information by transmitting an F1-AP message including the configuration information to the IAB node. If the communication node 400 is an NCR, the transmitter 210 of the gNB 200 may transmit the configuration information by transmitting the RRC message including the configuration information.

Thereafter, the communication node 400 transmits a DL command according to the configuration information (step S10). Subsequent steps (step S12 and step S13) are the same as or similar to those in the first embodiment and the second embodiment.

### Other Operation Example 1 According to Third Embodiment

Although an example in which the gNB 200 transmits the configuration information has been described in the third embodiment, entities that transmit the configuration information are not limited to the gNB 200. For example, the AMF 30 may transmit the configuration information to the communication node 400. In this case, if the communication node 400 is the gNB 200, a transmitter of the AMF 30 may transmit the configuration information by transmitting an NG-AP message including the configuration information to the gNB 200. If the communication node 400 is the UE 100, the transmitter of the AMF 30 may transmit the configuration information by transmitting a NAS message including the configuration information to the UE 100. If the communication node 400 is the IAB node or the NCR, the transmitter of the AMF 30 may transmit the configuration information by transmitting the NG-AP message including the configuration information.

### Other Operation Example 2 According to Third Embodiment

The configuration information (step S30 in FIG. 17) described in the third embodiment may include information indicating a frequency of communication of the communication node 400 with the ambient IoT device 300. The communication frequency may be, for example, a 10 ms cycle, one-shot (only once), or the like. By combining the communication frequency and the identification information of the ambient IoT devices 300 (or the identification information of the group to which the ambient IoT devices 300 belongs), the gNB 200 can also indicate the communication node 400 to acquire data from the specific ambient IoT devices 300 at the 10 ms cycle or through one BS transmission. When the communication frequency is used, the BS control information of the DL command may not include the frequency information and/or the communication timing information.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps do not need to be performed, and only some of the steps may be performed.

Although the example where the base station is an NR base station (gNB) has been described in the embodiments and examples described above, the base station may be an LTE base station (eNB) or a 6G base station.

The UE 100 may be a terminal function unit (a type of a communication module) for a base station to control a repeater that performs signal relay. Such a terminal function unit will be referred to as an MT. Examples of the MT include a Network Controlled Repeater (NCR)-MT and a Reconfigurable Intelligent Surface (RIS)-MT in addition to the IAB-MT.

The term “network node” mainly means a base station, but may also mean a core network apparatus or a part (CU, DU, or RU) of the base station. The network node may include a combination of at least a part of the core network apparatus and at least a part of the base station.

A program causing a computer to execute each processing performed by the UE 100, the gNB 200, the communication node 400, or the core network apparatus may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM and/or a DVD-ROM. Circuits that execute each processing to be performed by the UE 100, the gNB 200, the communication node 400, or the core network apparatus may be integrated, and at least a part of the UE 100, the gNB 200, the communication node 400, or the core network apparatus may be configured as a semiconductor integrated circuit (a chipset or a System on a Chip (SoC)).

The functions implemented by the UE 100, the gNB 200, the communication node 400, or the core network apparatus may be implemented in a circuitry or a processing circuitry programmed to implement the described functions, and including a general-purpose processor, a special-purpose processor, an integrated circuit, Application Specific Integrated Circuits (ASICs), a Central Processing Unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, and means are hardware programmed to achieve, or hardware performing the described functions. The hardware may be any hardware disclosed herein or any hardware programmed to implement or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on/in response to” means both “only depending on/in response to” and “at least partially depending on/in response to”. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### SUPPLEMENTARY NOTES

### Supplementary Note 1

A communication control method in a wireless communication system includes the steps of:
transmitting, at a communication node, at least one selected from the group consisting of a first unmodulated signal, a preamble signal, a signal representing identifier information of an IoT device, and a signal representing control information relating to backscattering transmission as a transmission signal to the IoT device;
receiving, at the IoT device, the transmission signal;
transmitting, the communication node, the second unmodulated signal; and
performing, at the IoT device, the backscattering transmission on the second unmodulated signal using the transmission signal.

### Supplementary Note 2

The communication control method according to Supplementary Note 1, wherein the first unmodulated signal is used to determine reference electric power for the second unmodulated signal in the IoT device.

### Supplementary Note 3

The communication control method according to Supplementary Note 1 or 2, wherein the preamble signal is used for time synchronization in the IoT device.

### Supplementary Note 4

The communication control method according to any one of Supplementary Notes 1 to 3, wherein the identifier information of the IoT device indicates information of designating the IoT device configured to perform the backscattering transmission.

### Supplementary Note 5

The communication control method according to any one of Supplementary Notes 1 to 4, wherein the control information includes at least one selected from the group consisting of transmission mode information indicating one of active transmission of performing transmission using an internal power supply, and passive transmission of performing transmission using a reception wave as a power supply, frequency information indicating information relating to a frequency used for the backscattering transmission, communication timing information indicating a communication timing of the backscattering transmission, and communication mode information indicating a communication mode of the IoT device.

### Supplementary Note 6

The communication control method according to Supplementary Note 1 further includes transmitting, at a network apparatus, configuration information to the communication node, wherein the transmitting of the transmission signal includes transmitting, at the communication node, the transmission signal to the IoT device based on the configuration information.

### Supplementary Note 7

The communication control method according to any one of Supplementary Notes 1 to 6, wherein the configuration information includes the identifier information and/or the control information.

### Supplementary Note 8

The communication control method according to any one of Supplementary Notes 1 to 7, wherein the configuration information includes an indication to activate one or more pieces of the configuration information among a plurality of pieces of configuration information, and/or an indication to deactivate the one or more pieces of configuration information among the plurality of pieces of configuration information.

### Supplementary Note 9

The communication control method according to any one of Supplementary Notes 1 to 8, wherein the configuration information includes information indicating a timing at which the communication node transmits the transmission signal.

### Supplementary Note 10

The communication control method according to any one of Supplementary Notes 1 to 9, wherein the configuration information includes information of indicating the communication node to transmit the transmission signal.

### Supplementary Note 11

A user equipment in a wireless communication system includes a transmitter configured to transmit a transmission signal including at least one selected from the group consisting of a first unmodulated signal, a preamble signal, a signal representing identifier information of an IoT device, and a signal representing control information relating to backscattering transmission to the IoT device, wherein
the transmitter is configured to transmit a second unmodulated signal, and
the IoT device is configured to perform the backscattering transmission on the second unmodulated signal using the transmission signal.

### REFERENCE SIGNS

1: Wireless communication system
10: NG-RAN
20: 5GC (CN)
30: AMF
100: UE
110: Receiver
120: Transmitter
130: Controller
200: gNB
210: Transmitter
220: Receiver
230: Controller
300: Ambient IoT Device
310: Antenna
320: Modulator
330: Controller
340: Memory
400: Communication node
410: Base station
420: Intermediate node
430: Assisting node

1. A communication control method in a wireless communication system, the communication control method comprising:
transmitting, by a communication node, a message including configuration information relating to transmission from an IoT (Internet of Things) device to the communication node to the IoT device, wherein
the configuration message includes frequency information indicating how much a frequency is apart from a predetermined frequency, and
the transmission is performed by the IoT device by using the frequency information.

2. The communication control method according to claim 1, wherein the configuration information includes timing information relating the transmission.

3. A communication node in a wireless communication system, the communication node comprising a transceiver circuitry and a processing circuitry operatively associated with the transceiver circuitry and configured to execute processing of:
transmitting a message including configuration information relating to transmission from an IoT device to the communication node to the IoT device, wherein
the configuration message includes frequency information indicating how much a frequency is apart from a predetermined frequency, and
the transmission is performed by the IoT device by using the frequency information.

4. A wireless communication system comprising a communication node and a IoT device, wherein
the communication node is configured to transmit a message including configuration information relating to transmission from an IoT device to the communication node to the IoT device,
the configuration message includes frequency information indicating how much a frequency is apart from a predetermined frequency, and
the IoT device is configured to perform the transmission by using the frequency information.

5. A non-transitory computer-readable medium storing instructions that, when executed by a processor of a communication node in a wireless communication system, cause the processor to carry out the method according to claim 1.

6. A chipset for a communication node in a wireless communication system, the chipset configured to execute the instructions stored on the non-transitory computer-readable medium of claim 5.
